(19) United States
(12) Patent Application Publication
(10) Pub. No.: US 2022/0370279 A1
(43) Pub. Date: Nov. 24, 2022

(54) Joint Cracking Device

(71) Applicants: Penny Qualls, Broken Bow, OK (US); Connor Gammon, Broken Bow, OK (US)

(72) Inventors: Penny Qualls, Broken Bow, OK (US); Connor Gammon, Broken Bow, OK (US)

(21) Appl. No.: 17/570,462

(22) Filed: Jan. 7, 2022

Related U.S. Application Data
(60) Provisional application No. 63/189,885, filed on May 18, 2021.

(51) Int. Cl. A61H 1/00

(52) U.S. Cl. CPC A61H 1/008; A61H 2201/0103; A61H 2201/1238; A61H 2201/1676; A61H 2203/0406; A61H 2205/06; A61H 2201/5025

(57) ABSTRACT

The present invention relates generally to the field of joint cracking. More specifically, the present invention relates to a joint cracking device. The device is primarily comprised of a body further comprised of at least one vertical support, at least one cushion, at least one hinge, at least one semi-circular member, and a base. To use the device, a user steps onto the base and positions their body within the semi-circular member. The user then presses a button to inflate an inflatable cuff on the interior surface of the member such that the user is secured within the member. Then, the member is rotated upwards such that the back of the user is cracked on the cushion, which is preferably convex in shape. Then, the member is returned to its original position, wherein the user can then crouch downwards to exit the member.

### CROSS-REFERENCE TO RELATED APPLICATION

The present application claims priority to, and the benefit of, U.S. Provisional Application No. 63/189,885, which was filed on May 18, 2021, and is incorporated herein by reference in its entirety.

### FIELD OF THE INVENTION

The present invention relates generally to the field of joint cracking. More specifically, the present invention relates to a joint cracking device. The device is primarily comprised of a body further comprised of at least one vertical support, at least one cushion, at least one hinge, at least one semi-circular member, and a base. To use the device, a user steps onto the base and positions their body within the semi-circular member. The user then presses a button to inflate an inflatable cuff on the interior surface of the member such that the user is secured within the member. Then, the member is rotated upwards such that the back of the user is cracked on the cushion, which is preferably convex in shape. Then, the member is returned to its original position, wherein the user can then crouch downwards to exit the member. Accordingly, the present disclosure makes specific reference thereto. Nonetheless, it is to be appreciated that aspects of the present invention are also equally applicable to other like applications, devices and methods of manufacture.

### BACKGROUND

Many individuals suffer from tense neck and back muscles as well as neck and back pain. Said individuals may find relief from said pain by cracking their back, which stretches capsules on the outer edges of the vertebrae in order to allow synovial fluid to flow inside the capsules and release pressure in the spinal cord and in the surrounding muscles. However, cracking a back typically involves a second individual who lifts a first individual off the ground in order to crack their back. This cannot then be accomplished with no second individual available, and as a result the first individual cannot gain relief from having their back cracked without said second individual.

Therefore, there exists a long-felt need in the art for a device that allows a user to crack the joints and muscles in their back and neck area. There also exists a long-felt need in the art for a joint cracking device that allows a user to crack the joints and muscles in their back and neck area, but does not require a second user to operate the device. Further, there exists a long-felt need in the art for a joint cracking device that allows a user to crack the joints and muscles in their back and neck area but does not require a second user to operate the device, and wherein the device does not require substantial physical strength or flexibility to use.

The subject matter disclosed and claimed herein, in one embodiment thereof, comprises a joint cracking device. The device is primarily comprised of a body further comprised of at least one vertical support, at least one cushion, at least one hinge, at least one semi-circular member, and a base. To use the device, a user steps onto the base and positions their body within the semi- circular member. The user then presses a button to inflate an inflatable cuff on the interior surface of the member such that the user is secured within the member. Then, the member is rotated upwards such that the back of the user is cracked on the cushion, which is preferably convex in shape. Then, the member is returned to its original position, wherein the user can then crouch downwards to exit the member.

In this manner, the joint cracking device of the present invention accomplishes all of the forgoing objectives and provides a joint cracking device that allows a user to crack the joints and muscles in their back and neck area without requiring a second user to operate the device. Further, the joint cracking device does not require substantial physical strength or flexibility to use. In this manner, the joint cracking device overcomes the limitations of existing methods of cracking joints and muscles known in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a joint cracking device. The device is primarily comprised of a body further comprised of at least one vertical support, at least one cushion, at least one hinge, at least one semi-circular member, and a base. The body is preferably manufactured from a durable metal such as, but not limited to stainless-steel or aluminum. The base is preferably rectangular and has a flat top surface and a generally parallel bottom surface, as well as two pairs of generally parallel side surfaces. The vertical support further fixedly or removably attaches to the top surface and/or side surface of the base and is further comprised of at least one horizontal member and at least one horizontal member. The front surface of the vertical support is further comprised of at least one cushioned pad made from a rigid or semi-rigid foam material that is preferably convex in shape.

The vertical support is also comprised of at least one semi-circular member that preferably attaches to the front surface of the vertical support via at least one (but preferably two) hinge(s). The hinge is preferably a motorized hinge that is powered by an electric motor that may be stored within the base and/or the semi-circular member. The motor is further powered by a battery. The interior surface of the member is further comprised of a rubber, inflatable cuff. When a user is standing on the base such that the user's torso within the semi-circular member, the cuff can be inflated via a pump by pressing at least one button that may be located on the outer surface and/or top surface of the member. As a result, the cuff can press against the torso and/or arms of the user such that the user is secured within the member. The button may also allow a user to increase or decrease the inflation level of the cuff for comfort.

To use the device, a user first steps onto the top surface of the base and then through the semi-circular member by crouching below the member and then entering from the bottom of the member such that their back is on the pad. It should be noted that in the default position, the member is positioned parallel with the top surface of the base. However, in one embodiment a user may simply press the button to rotate the member upwards until a user can comfortably stand under the member. Then, the button can be pressed to cause the member to rotate downwards such that the member is around the user and covers the torso of the user. Next, the user can place their arms diagonally across their torso or on the sides/back of their neck. However, before doing so the user preferably presses the button to begin inflating the inflatable cuff around their arms and/or torso. Once the cuff fully inflates, the hinge is then automatically activated by the motor such that the semi-circular member rotates upwards away from the base. As a result, the user is also picked up by the member and suspended above the base. The hinge continues moving upward until it reaches a stopping point, wherein the suspension of the user and the convex shape of the pad cracks the back of the user. Once at the stopping point, the hinge may keep the semi-circular member at said position for a brief period of time before rotating the member downward back to the neutral position (i.e., wherein the member is parallel with the top surface). At this point, the user's feet are returned to the top surface and the cuff deflates, thus allowing the user to crouch downwards and out from the semi-circular member.

Accordingly, the joint cracking device of the present invention is particularly advantageous as it provides a device that allows a user to crack the joints and muscles in their back and neck area without requiring a second user to operate the device. Further, the joint cracking device does not require substantial physical strength or flexibility to use. In this manner, the joint cracking device overcomes the limitations of existing methods of cracking joints and muscles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a joint cracking device of the present invention in accordance with the disclosed architecture;

FIG. 2 illustrates an enhanced perspective view of one potential embodiment of a joint cracking device of the present invention in accordance with the disclosed architecture;

FIG. 3 illustrates an enhanced perspective view of one potential embodiment of a joint cracking device of the present invention while a user is in the device in accordance with the disclosed architecture;

FIG. 4 illustrates a perspective view of one potential embodiment of a joint cracking device of the present invention while a user is in the device in accordance with the disclosed architecture; and

FIG. 5 illustrates a perspective view of one potential embodiment of a joint cracking device of the present invention while a user is in the device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that allows a user to crack the joints and muscles in their back and neck area. There also exists a long-felt need in the art for a joint cracking device that allows a user to crack the joints and muscles in their back and neck area but does not require a second user to operate the device. Further, there exists a long-felt need in the art for a joint cracking device that allows a user to crack the joints and muscles in their back and neck area but does not require a second user to operate the device, and wherein the device does not require substantial physical strength or flexibility to use.

The present invention, in one exemplary embodiment, is comprised of a joint cracking device. The device is primarily comprised of a body further comprised of at least one vertical support, at least one cushion, at least one hinge, at least one semi-circular member, and a base. To use the device, a user steps onto the base and positions their body within the semi-circular member. The user then presses a button to inflate an inflatable cuff on the interior surface of the member such that the user is secured within the member. Then, the member is rotated upwards such that the back of the user is cracked on the cushion, which is preferably convex in shape. Then, the member is returned to its original position (parallel with the top surface of the base), wherein the user can then crouch downwards to exit the member.

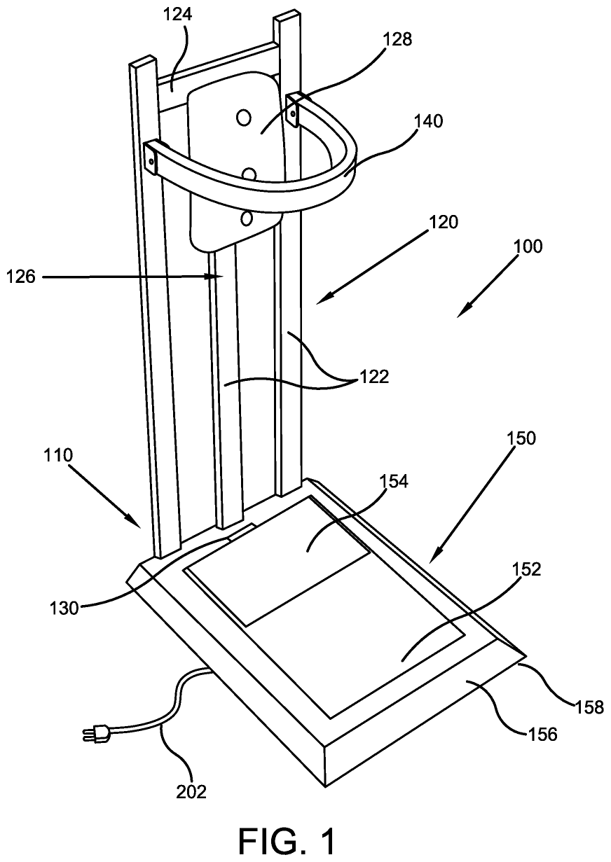

Referring initially to the drawings, FIG. 1 illustrates a perspective view of one potential embodiment of a joint cracking device 100 of the present invention in accordance with the disclosed architecture. The device 100 is primarily comprised of a body 110 further comprised of at least one vertical support 120, at least one cushion 128, at least one hinge 130, at least one semi- circular member 140, and a base 150. The body 110 is preferably manufactured from a durable metal such as, but not limited to stainless-steel or aluminum. The body 110 may further be any color known in the art and may have a plurality of indicia 190 such as, but not limited to: patterns, logos, emblems, images, symbols, designs, letters, numbers, words, characters, animals, advertisements, brands, etc.

The base 150 is preferably rectangular, but in differing embodiments may be any shape known in the art such as, but not limited to: square, oval, circular, triangular, octagonal, etc. The base 150 is further comprised of a flat top surface 152 and a generally parallel bottom surface 158, as well as two pairs of generally parallel side surfaces 156. In one embodiment, the top surface 152 may have a non-slip, texture. The vertical support 120 further fixedly or removably attaches to the top surface 152 and/or side surface 156 of the base 150. The vertical support 120 is further comprised of at least one horizontal member 122 and at least one horizontal member 124. However, in the preferred embodiment of the device 100 the vertical support has 3 vertical members 122 and 2 horizontal members 124.

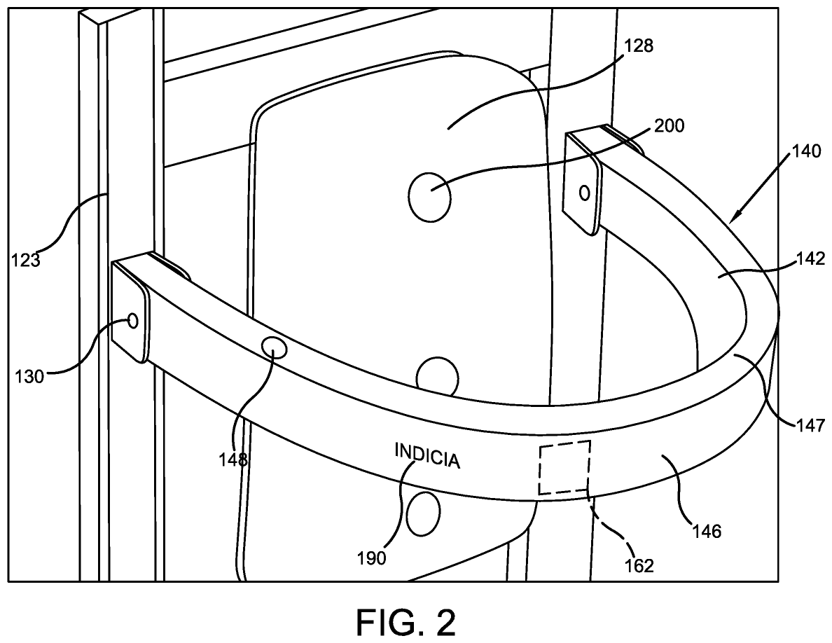

FIG. 2 illustrates an enhanced perspective view of one potential embodiment of a joint cracking device 100 of the present invention in accordance with the disclosed architecture. The front surface 126 of the vertical support 120 is further comprised of at least one cushioned pad 128. In differing embodiments, the cushioned pad 128 may further be moisture wicking and made from a rigid or semi-rigid foam material. The pad 128 may further be fixedly or removably attached to the vertical members 122 and/or horizontal members 124 of the front surface 126 via at least one fastener 200 such as, but not limited to: hook and loop, magnet, tongue and grove, screw, bolt, nail, adhesive, etc. The pad 128 is further preferably convex in shape.

The vertical support 120 is also comprised of at least one rotating semi-circular member 140. However, in differing embodiments the rotating member 140 may be any shape known in the art. The member 140 preferably attaches to the front surface 126 of the vertical support 120 via at least one (but preferably two) hinge(s) 130. The hinge 130 is preferably a motorized hinge 130. However, in differing embodiments the hinge 130 may be any hinge-type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 130 is further powered by an electric motor 160 that may be stored within the base 150 and/or the semi-circular member 140.

The motor 160 is further powered by a battery 170. The battery 170 may be a disposable battery 170 or a rechargeable battery 170 in the form of an alkaline, nickel-cadmium, nickel-metal hydride battery 170, etc. such as any 3V-12volts DC battery 170 or other conventional battery 170 such as A, AA, AAA, etc. that supply power to the device 100. Throughout this specification the terms “battery” and “batteries” may be used interchangeably to refer to one or more wet or dry cells or batteries 170 of cells in which chemical energy is converted into electricity and used as a source of DC power. References to recharging or replacing batteries 170 may refer to recharging or replacing individual cells, individual batteries 170 of cells, or a package of multiple battery cells as is appropriate for any given battery 170 technology that may be used. Additionally, the battery 170 may be recharged or powered by a power cord 202 that can be plugged into a 110V/240V wall outlet.

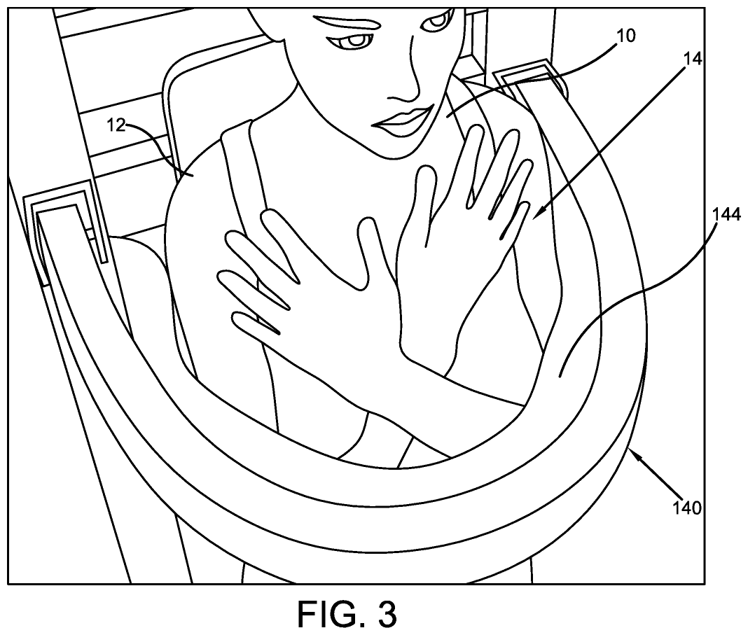

FIG. 3 illustrates an enhanced perspective view of one potential embodiment of a joint cracking device 100 of the present invention while a user 10 is in the device in accordance with the disclosed architecture. The interior surface 142 of the member 140 is further comprised of an inflatable cuff 144 that is preferably made of rubber. When a user 10 is standing on the base 150 such that the user's 10 torso 14 is within the semi-circular member 140, the cuff 144 can be inflated by pressing at least one button 148 that may be located on the outer surface 146 and/or top surface 147 of the member 140. The cuff 144 is further inflated via a pump 162 that is powered by the motor 160 and that is preferably housed within the semi-circular member 140. As a result, the cuff 144 can press against the torso 14 and/or arms 16 of the user 10 such that the user 10 is secured within the member 140. The button 148 may also allow a user 10 to increase or decrease the inflation level of the cuff 144 for comfort.

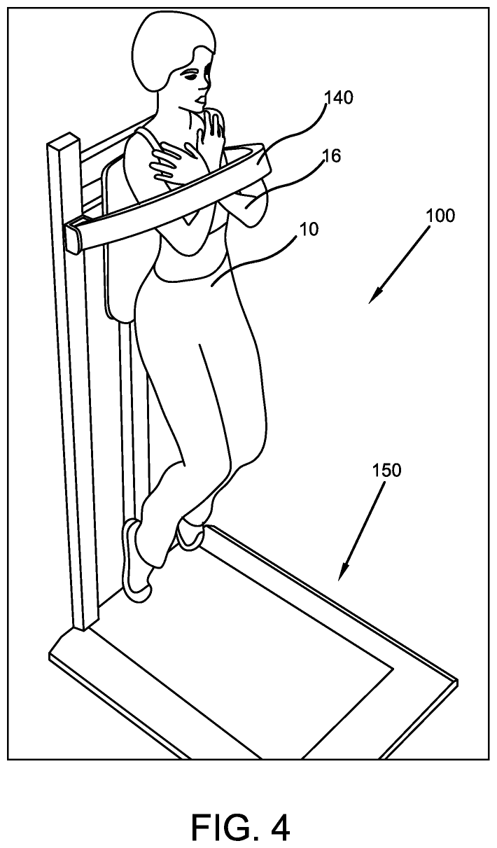

FIG. 4 illustrates a perspective view of one potential embodiment of a joint cracking device 100 of the present invention while a user 10 is in the device 100 in accordance with the disclosed architecture. To use the device 100, a user 10 first steps onto the top surface 152 of the base 150 and then through the semi-circular member 140 by crouching below the member 140 and then entering from the bottom of the member 140 such that their back 12 is on the pad 128. It should be noted that in the default position, the member 140 is positioned parallel with the top surface 152 of the base 150. However, in one embodiment a user may simply press the button 148 to rotate the member 140 upwards until a user 10 can comfortably stand under the member 140. Then, the button 148 can be pressed to cause the member 140 to rotate downwards such that the member 140 is around the user 10 and covers the torso 14 of the user 10. Next, the user 10 can place their arms 16 diagonally across their torso 14 or on the sides/back of their neck 20. However, before doing so the user 10 preferably presses the button 148 to begin inflating the inflatable cuff 144 around their arms 16 and/or torso 14. After the cuff 144 fully inflates, the hinge 130 is then automatically activated by the motor 160 such that the semi-circular member 140 rotates upwards away from the base 150 (within a 180-degree range of movement). In this manner, the user 10 is also picked up by the member 140 and suspended above the base 150. The hinge 130 continues rotating upward until it reaches a stopping point. During the upward rotation and before the stopping point, the suspension of the user 10 and the convex shape of the pad 128 cracks the back of the user 10. Once at the stopping point, the hinge 130 may keep the semi-circular member 140 at said position for a brief period of time before rotating the member 140 downward back to the neutral position wherein the member 140 is parallel with the top surface 152. At this point, the user's 10 feet 18 are returned to the top surface 152 and the cuff 144 deflates, thus allowing the user to crouch downwards and out from the semi-circular member 140.

However, it should be noted that in one embodiment the hinge 130 is attached to at least one movable track 123 located on at least one vertical member 122 of the vertical support 120. The at least one button 148 then allows a user 10 to raise and lower the position of the semi- circular member 140 on the vertical members 122 using the track 123. As a result, this eliminates the need for a user 10 to crouch down and enter the semi-circular member 140 from below the member 140. Instead, a user 10 can stand on the base 150 and simply raise the member 140 to a height that is above their head using the rack 123. The user 10 can then lower the member 140 around their torso 14 and the device 100 can then be used as described above. Accordingly, this embodiment is advantageous for users 10 who may lack the physical ability to crouch down to enter the member 140 from below.

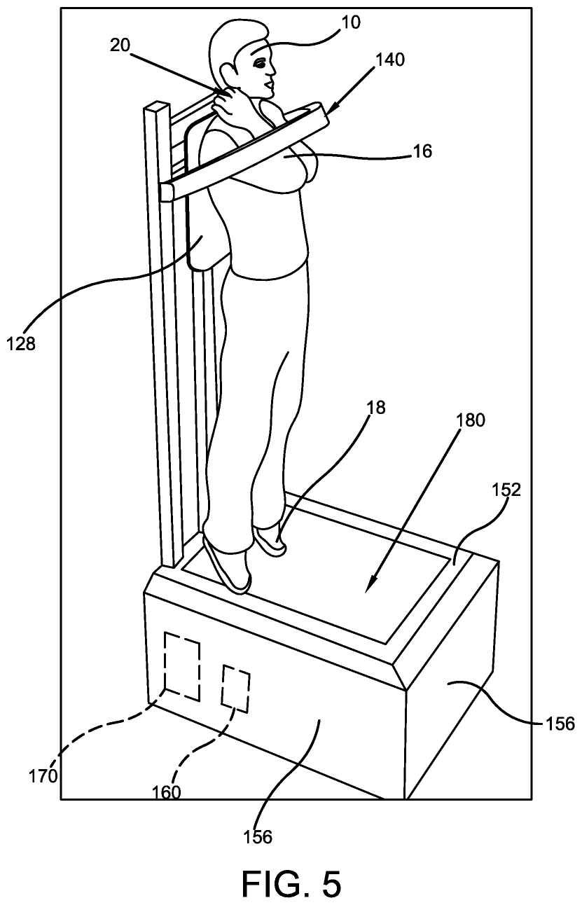

FIG. 5 illustrates a perspective view of one potential embodiment of a joint cracking device 100 of the present invention while a user is in the device in accordance with the disclosed architecture. In a differing embodiment, the side surfaces 156 of the base 150 are of a height such that an interior space 180 is formed within the base 150. The top surface 152 of the base 150 is further comprised of a motorized door 154 that is attached to the top surface 152 via at least one hinge 130 that is powered by the motor 160 such that the door 154 drops into the interior space 180 of the base 150 after a user 10 has positioned themselves within the semi-circular member 140 and the member 140 has begun to move upwards. In this manner, the user 10 is further suspended and their feet 18 are not touching any portion of the base 150.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “joint cracking device” and “device” are interchangeable and refer to the joint cracking device 100 of the present invention.

Notwithstanding the forgoing, the joint cracking device 100 of the present invention and its various components can be of any suitable size and configuration as is known in the art without affecting the overall concept of the invention, provided that they accomplish the above- stated objectives. One of ordinary skill in the art will appreciate that the size, configuration and material of the joint cracking device 100 as shown in the FIGS. are for illustrative purposes only, and that many other sizes and shapes of the joint cracking device 100 are well within the scope of the present disclosure. Although the dimensions of the joint cracking device 100 are important design parameters for user convenience, the joint cracking device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A joint cracking device comprising:
a base;
a vertical support attached to the base;
a pad;
an inflatable cuff;
a rotating member attached to the vertical support by a pair of hinges;
a motor;
a battery; and
a pump that inflates the inflatable cuff.

2. The joint cracking device of claim 1, wherein the inflatable cuff is located on an interior surface of the rotating member.

3. The joint cracking device of claim 2, wherein the inflatable cuff can be inflated by pressing at least one button which activates the pump.

4. The joint cracking device of claim 1, wherein the pair of hinges are motorized.

5. The joint cracking device of claim 3, wherein the pair of hinges are powered by the motor.

6. A joint cracking device comprising:
a base;
a vertical support comprised of a vertical member and a horizontal member;
a convex pad;
an inflatable cuff;
a rotating member attached to the vertical support by a pair of hinges;
a motor;
a battery; and
a pump that inflates the inflatable cuff.

7. The joint cracking device of claim 6, wherein the inflatable cuff is located on an interior surface of the rotating member.

8. The joint cracking device of claim 7, wherein the inflatable cuff can be inflated by pressing at least one button which activates the pump.

9. The joint cracking device of claim 6, wherein the pair of hinges are motorized.

10. The joint cracking device of claim 9, wherein the pair of hinges are powered by the motor.

11. A joint cracking device comprising:
a base comprised of a top surface, a bottom surface and a plurality of side surfaces;
a vertical support comprised of a vertical member, a track and a horizontal member;
a pad;
an inflatable cuff;
a rotating member attached to the vertical support by a pair of hinges;
a motor;
a battery; and
a pump that inflates the inflatable cuff.

12. The joint cracking device of claim 11, wherein the inflatable cuff is located on an interior surface of the rotating member.

13. The joint cracking device of claim 12, wherein the inflatable cuff can be inflated by pressing at least one button which activates the pump.

14. The joint cracking device of claim 11, wherein the pair of hinges are motorized.

15. The joint cracking device of claim 14, wherein the pair of hinges are powered by the motor.

16. The joint cracking device of claim 11, wherein the track allows the pair of hinges and the rotating member to be raised and lowered on the vertical support.

17. The joint cracking device of claim 11, wherein the base is further comprised of a door on a top surface of the base.

18. The joint cracking device of claim 11 further comprised of a power cord.

19. The joint cracking device of claim 11, wherein the pad is convex in shape.

20. The joint cracking device of claim 11, wherein the rotating member has a 180-degree range of motion.
